(19) United States
(12) Patent Application Publication
(10) Pub. No.: US 2013/0054138 A1
(43) Pub. Date: Feb. 28, 2013

(54) Global positioning and timing system and method for race start line management

(71) Applicant: Stephen E. Clark, Norfolk, VA (US)

(72) Inventor: Stephen E. Clark, Norfolk, VA (US)

(21) Appl. No.: 13/199,204

(22) Filed: Aug. 23, 2011

(51) Int. Cl. G01C 21/00

(52) U.S. Cl. 701/468; 701/482

(57) ABSTRACT

A system and method for positioning control and management of racing sailboat positions and velocities includes the strategic placement of a global positioning receiver on the sailboat. Global positioning system (GPS) receiver unit receives GPS signals from positioning satellites. Prior to starting a race, the sailboat takes two line shots of the starting line from beyond one or both ends of the starting line. In response to operator selection via a user input interface connected to the GPS receiver, the boat's respective positions at which the two line shots are taken are each recorded by a processor connected to the GPS receiver. The processor calculates the equation of a straight line corresponding to that of the extended starting line, and plots it in an x-y plane. The processor additionally continuously determines the boat's current location, speed and bearing relative to the start line, and plots its current course in the same x-y plane as the starting line. The processor calculates the projected point of intersection of the boat's current course with the starting line, and produces a visual and/or audible output describing the amount of time until the boat crosses the start line.

### TECHNICAL FIELD

The present invention relates to integrated global positioning system (GPS) communications networks, and particularly to communications and automated global positioning determination of racing vehicle information indications.

### BACKGROUND OF THE INVENTION

The start of a sailboat race is unlike the start of any other racing event. Several variable factors contribute to this uniqueness; and these factors, both individually and in combination with each other, introduce problems that need to be considered and addressed by sailors at the start of each race.

Sailboat races typically have running starts. That is, unlike, say, a foot race or a swim race where each runner or swimmer starts from a dead stop, sailboat races start with each boat moving toward the starting line, building up momentum long before the starting signal is given. Ideally, the boat reaches the starting line at full speed an instant after the starting horn is blown. Should the boat cross the starting line before the starting signal is given, the boat will be penalized, typically requiring that the boat circle back and re-cross the starting line and effectively forfeit several seconds, if not minutes, of valuable race time. On the other hand, should the boat delay in crossing the starting line until long after the starting signal has been given, an advantage in both time and position may be ceded to the other boats in the fleet.

Accordingly, it is advantageous in sailboat racing to be able to estimate time of traversal over the start line with great accuracy.

There are, however, several factors, almost none of which is present in other types of racing events, that make it difficult to accurately predict the time of transversal over the start line in sailboat races.

Unlike races that are conducted over land, in sailboat racing there is no actual visible painted, printed or otherwise inscribed line that extends across, and easily identifies, the start line. The starting line in a sailboat race typically comprises two physical structures, between which a virtual line extends across the open water, indicating the start line. In a typical racing format, a race committee boat (or more particularly, a flag pole affixed to an anchored race committee boat) constitutes one end of the starting line; and an anchored buoy (the “pin”) constitutes the other end of the starting line. Typically, determination as to when a boat crosses the starting line is made by a person (the “starter”) stationed on the race committee boat, sighting along the starting line to the pin at the opposite end of the starting line. A boat is considered to have reached the starting line when its bow crosses the line of sight of the starter who is sighting from the committee boat, along the start line, to the pin.

At the beginning of a race, when numerous boats may be crossing the starting line at about the same time, it can be difficult for a racer to discern when the boat has crossed the start line, as other boats may be blocking the racer's sight lines up and down the start line.

Additionally, because a racing boat is necessarily positioned at the beginning of a race between the structures (i.e., the race committee boat and the pin) that mark the opposite ends of the starting line, it is impossible for a person on a racing boat to be looking at both end structures simultaneously as the boat crosses the starting line.

In order to overcome these problems, a common pre-race practice is to sail beyond an end of the starting line, then position the boat such that the sailboat, the pin and the race committee boat are in a straight line. If possible, notice is made of a landmark (typically onshore, often far beyond the end of the starting line) that appears to be in line with the starting line. This is referred to as taking a “line shot”. This landmark is then used, along with either the committee boat or the pin, as a reference to indicate when one's boat has crossed the starting line at the beginning of the race. If possible, it is usually desirable to take a line shot from beyond each end of the starting line, as one or the other of the landmarks may be blocked from sight (such as by other competitors' boats) when the race actually begins. This strategy is problematic because there is not always a nearby landmark, much less a perfectly aligned landmark, to use for this purpose.

Accordingly, it would be desirable to have a method or apparatus by which a sailor can determine when his boat has crossed a starting line that does not rely on such, often distant, landmarks for line shots.

Another characteristic that is unique to sailboat race starts is that the racers in sailboat races almost never leave the starting line going in a direction that is at an angle (i.e., other than perpendicular) to the starting line. In virtually every other type of sporting race, racers leave the start line initially on a course that is perpendicular to the start line. In a typical sailboat race, the first leg of the race is upwind. That is, the first mark that must be rounded by the racers is generally located upwind of the starting line. Since sailboats cannot sail directly into the wind, it is therefore necessary for the racers to leave (and approach) the starting line at an angle (i.e., other than perpendicular to the starting line).

The distance between a first point and a reference line is usually taken to be the shortest distance between the first point and the line. This corresponds to a distance from the first point, to a point on the reference line, measured along a second line that is perpendicular to the reference line. The time it takes to travel from the first point to the reference line, then, can be simply calculated by dividing the distance to the line by the speed of travel toward the line. However, because sailboats almost never approach starting lines at a right angle, the perpendicular distance from the boat to the finish line is largely irrelevant. In sailboat racing, it is therefore difficult to accurately determine the time it takes to travel (from a given point on the water) to an arbitrary location along the starting line, even when the structures marking the opposite ends of the starting line are visible and the approximate speed of the boat is known.

Another characteristic that is unique to boat races is that the precise geographic location and orientation of a starting line (that is, the precise location of the committee boat and the pin that mark the opposite ends of the starting line) is almost never known well in advance of a race; and, in any event, the location and/or orientation of the starting line may well change from race to race, depending on many variables (notably wind speed and direction).

Since there is a virtually infinite number of possible geographic locations and orientations for starting lines, even for sailboat races that are repeatedly held in the same waterways, it has been found impractical to pre-program starting lines into marine-based navigation systems.

Another characteristic that is unique to sailboat races is that variables such as changing wind conditions, and changing positions, tacks (starboard or port), bearings and speeds of other competitors, influence the speed, angle of approach and/or location along the starting line at which a racer may choose to cross the starting line. Since the speed, angle of approach and/or the location along the starting line may change at any time (and, in fact, may change several times) before, and up until, the boat crosses the starting line, the time- and distance-to-crossing the starting line can vary considerably and be difficult to estimate during the starting sequence of a sailboat race.

U.S. Pat. No. 5,731,788 to Reeds discloses a global positioning and communications system for race and start line management that purports to overcome some of the aforementioned problems in the prior art.

Differential GPS systems and methods are generally known. Such systems and methods are summarized in a survey article by Earl G. Blackwell, “Overview of Differential GPS Methods,” 32 Journal of The Institute of Navigation, (No. 2, Summer 1985). The article describes, among other things, how a local GPS reference receiver (RR) can be employed to eliminate common errors in the GPS navigation solution of other nearby receivers. As is well known, GPS systems permit users equipped with suitable receivers to make accurate position, velocity, and time determinations worldwide with reference to GPS satellites, which are in 12 hour (19,000 km) orbits about the earth. Such satellites continuously broadcast their identification, position, and time using specially coded signals.

In the Reeds system, a first Global Positioning System (“GPS”) transceiver is advantageously positioned (for example on a race committee boat) at one end of a starting line; a second GPS transceiver is advantageously positioned (for example on a fixed buoy) at the opposite end of a starting line; and a third GPS transceiver is advantageously positioned on at least one racing sailboat. In the Reeds system, the location of the start line is calculated based on data received from the first and second GPS transceivers, which communicate their respective locations to a receiver (or receivers) which may be located on the committee boat and/or on the racing sailboat(s). Those receivers are in communication with processors that calculate the location of the starting line. The third GPS transceiver communicates its position (and, consequently, the position of the sailboat on which it is mounted) at predetermined time intervals to the processors. Based on the data received from the first, second and third GPS transceivers, the processor can monitor and display the sailboat's position, bearing, speed relative to the starting line, and can calculate and display such additional information as distance from boat to starting line, location at which boat will cross the starting line, and time at which boat will cross the starting line.

One disadvantage of the Reeds system is that a minimum of three GPS transceivers (namely, one fixed at each end of the starting line and one on a racing sailboat) are necessary for operation of the system. This means that, not only must the racing competitor bear the financial costs associated with outfitting his boat with GPS equipment, but the race organizers must procure and maintain at least two of their own transceivers (namely, one for the committee boat and one for the pin).

Another disadvantage of the Reeds system is that control of the system is out of the hands of individual racers. If the race committee boat and the starting line buoy are not each outfitted (e.g., by the race committee) with the necessary GPS-based transceiver equipment, then an individual racer cannot access the data that the operational Reeds system could provide.

Another disadvantage of the Reeds system is that, even if the race committee boat and the starting line buoy are each outfitted with GPS-based transceiver equipment, an individual racer still may not have access to the data that the operational Reeds system purports to provide, unless the individual racer is equipped with a GPS-based transceiver that is compatible with and tuned to the race committee boat's equipment.

Accordingly it would be desirable to enable the development of global positioning information which is of use in the correct setting of course and speed of sailboats nearing a race start line, and which information could be obtained by individual racers without reliance on any third party.

It is a common, though certainly not uniform, occurrence that the starting line of a sailboat race also serves as the finish line for the race. The racing boat is allowed to cross the finish line at any location between the ends of the line (which are typically marked by the committee boat at one end and a pin at the other end). Often there is a preferred end, or a preferred intermediate point along the line, at which to cross the finish line. Generally, the end that is closest to the approaching sailboat is the preferred end. However, it is often difficult to tell from several hundreds of yards (or more) away from the finish line, which end of the line is closest, and therefore which end is preferred.

Accordingly, it may be desirable to enable the development of global positioning information which is of use in the correct setting of course of sailboats nearing a race finish line.

### SUMMARY OF THE INVENTION

In light of the foregoing background, the present invention provides a position control and management system and method for monitoring and controlling boat or vehicle activities at a race start-line, during a race, and at the traversal of the race finish line by using an automated global positioning network to track at least one race boat or vehicle.

Further, the system according to the present invention provides for the development of global positioning information which is of use in the correct setting of course and speed of sailboats nearing a race start line, and which information could be obtained by individual racers without reliance on any third party.

Further, the system according to an embodiment of the present invention determines actual and anticipated crossing times for boats and vehicles at a race start line or finish line and provides for user friendly display of information indicating anticipated and actual line crossing times, estimated times of arrival (ETA) at a selected line crossing, positions, courses and velocities, and tracks of movement of one or more selected boats or vehicles prior to, during and after a race.

To accomplish position control and management, the communications network according to one embodiment of the present invention includes at least one racing boat having a GPS communication controller, and passive first and second physical structures disposed at opposite ends of a starting line.

According to one embodiment of the present invention, a GPS communication controller is located at or on the racing boat. The communication controller is adapted to contemporaneously record and store a first location, that location preferably corresponding to a position of the racing boat when the boat is located at a first point on (or on an extension of) the start line; and the communication controller is adapted to contemporaneously record and store a second location, that location preferably corresponding to a position of the racing boat when the boat is located at a second point on (or on an extension of) the start line, such that the controller can determine and record the geographic location of the start line (and extensions thereof).

The racing boat-carried GPS communication controller additionally monitors and displays the racing boat's varying position and velocity as a function of time.

According to one embodiment of the present invention, the racing boat carries data processing equipment to establish a formulation of the start line, and for calculation and display presentation of position and direction information relating to the start-line, and the racing sailboat preferably being established on a boat-positioned display to permit the skipper and crew members including but not limited to helmsman, tactician, and navigator to make decisions regarding velocity, tack, and positioning relative the start line, to monitor race progress and, for example, to avoid premature start-line crossage.

According to one embodiment of the present invention, the racing boat carries data processing equipment to establish a formulation of the finish line, and for calculation and display presentation of position and direction information relating to the finish line, and the racing sailboat preferably being established on a boat-positioned display to permit the skipper and crew members including but not limited to helmsman, tactician, and navigator to make decisions regarding velocity, tack, and positioning relative the finish line, to monitor race progress and, for example, to select an optimal location for crossing the finish line.

It is another object to provide an embodiment a racing boat-carried GPS communication controller of the character described that is portable and hand-held.

It is another object to provide an embodiment a racing boat-carried GPS communication controller of the character described that comprises a downloadable application (“app”) for hand-held “smart phones” and similar devices.

Other objects, features and advantages of the present invention will become readily apparent from the following detailed description of the preferred embodiment when considered with the attached drawings and the appended claims.

### BRIEF DESCRIPTION OF THE DRAWINGS

FIG. 1 is a diagram of a racing sailboat approaching a starting line defined by race committee boat and a start line buoy anchored in place at preselected locations;

FIG. 2 is a diagram of a sailboat positioned beyond the committee boat end of a start line for establishing a first end of a target line in accordance with the present invention;

FIG. 3 is a diagram of a sailboat positioned beyond the buoy end of a start line for establishing a second end of a target line in accordance with the present invention;

FIG. 4 is a diagram of a racing sailboat approaching a starting line defined by race committee boat and a start line buoy anchored in place at preselected locations;

FIG. 5 is a schematic representation of a display console including a data processing unit coupled to a display responsive to input position and residual indications determinative of the location of a sailboat in the vicinity of a racing start-line;

FIG. 6 is a block diagram of the electronics architecture of a communications system according to an embodiment of the present system; and,

FIG. 7 is a block flow diagram of a system for determining and displaying positioning and timing information of a sailboat in the vicinity of a racing start-line in accordance with an embodiment of the present invention.

### REFERENCE INDICIA IN DRAWINGS

C Course (of sailboat)
D Distance from current position (Pₐ) to the start point (Pₛ)
D1 Distance Indication on display screen
P1 first selected position
P2 second selected position
Pₐ, P_{b} Receiver positions recorded at two different times
Pₛ Start Point
W Wind direction
θ Angle of approach
3 Sailboat
9 Race start buoy
10 Race committee boat
11 Start line
11a, 11b Start line extensions
15 Race control GPS device, (general)
20 GPS receiver
22 GPS processor
23 Data processing unit
24 Location selection user interface
26 Data storage memory
28 Display screen
30 Display console
31 Sailboat icon
32 Target line graphic display
34 Antenna
36 Sound generator
38 Speed indication
40 Target Line
42 Time of Arrival indication
46 Course line graphic display
48 Intercept angle graphic display
101 Process: Receive Global positioning data from satellite
102 Process: Determine current global position
103 Process: Determine current global bearing
104 Process: Determine current speed over ground
105 Process: User input, Position 1
106 Process: User input, Position 2
107 Process: Store Position 1 data
108 Process: Store Position 2 data
109 Process: Convert global positioning data to local x-y coordinates
110 Process: Calculate equation of current path line
111 Process: Calculate equation of target line
112 Process: Calculate coordinates of intersection of path line and target line.
113 Process: Calculate distance to intersection point
114 Process: Calculate angle of intercept
115 Process: Calculate time to arrive at intercept
116 Process: Display output

### DETAILED DESCRIPTION OF THE PREFERRED EMBODIMENTS

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

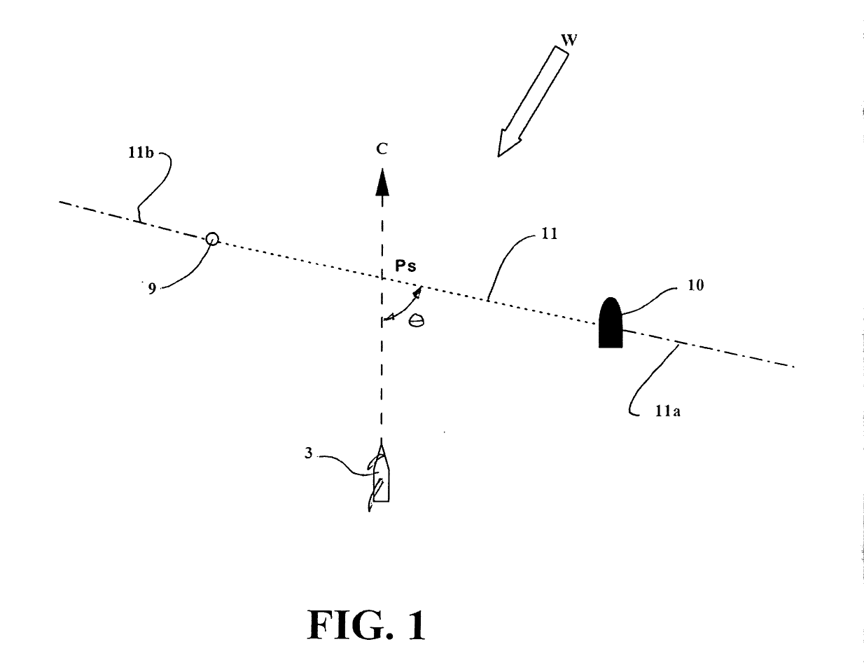

FIG. 1 shows a racing sailboat 3 sailing into the wind (W) on a starboard tack. Additionally shown in FIG. 1 are a race start buoy 9 and a racing committee boat 10 jointly defining a start line 11 for a sailboat race in which sailboat 3 is participating. Start line extensions 11a and 11b extend beyond the committee boat 10 and start buoy 9 at opposite ends of the start line 11. Sailboat 3 has a race control global positioning system (GPS) device (generally indicated as 15 in the Figures) mounted thereupon or maintained therein for communicating with a plurality of global positioning system satellites (not shown) for receiving global positioning signals indicative of pseudoranges with respect to the satellites.

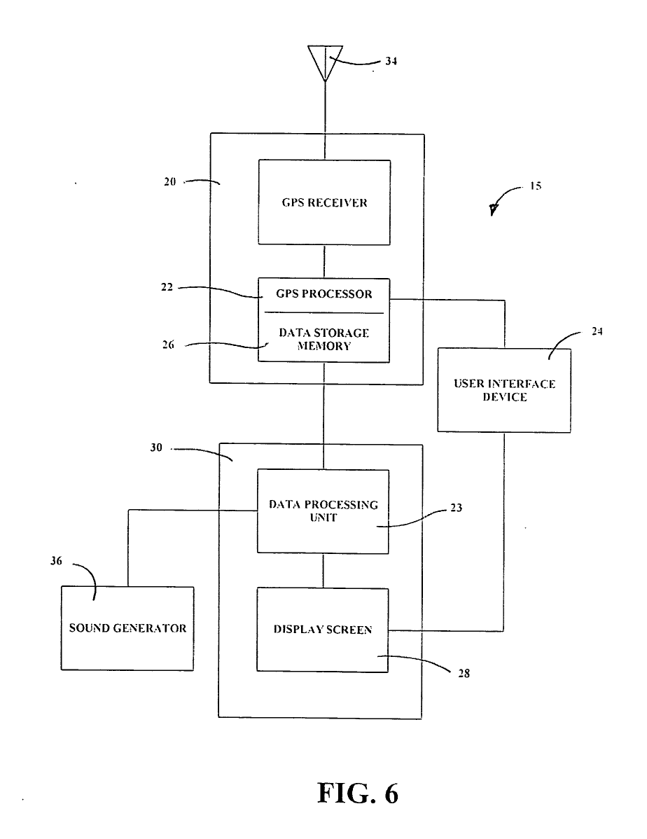

Referring now to FIG. 6: According to the invention, the race control GPS device 15 comprises an antenna 34 connected to GPS receiver 20, and a GPS processor 22, which is also connected to GPS receiver 20. Radio transmissions from the satellites are broadcasted continually. The GPS receiver 20 picks up these broadcasts and through triangulation calculates the spatial position (herein referred to as the “global position”) of the receiving unit. A minimum of three satellites is required for triangulation. As long as the GPS receiver 20 receives GPS signals from a sufficient number of satellites, GPS processor 22 can compute its current global position based upon pseudoranges determined from signals received from the satellites. In a preferred embodiment of the invention, global positions computed by the race control GPS device 15 are indentified according to the positions' respective longitude and latitude.

The race control GPS device 15 additionally comprises a location selection user interface 24 and data storage memory 26 in communication with the GPS processor 22. When the location selection user interface 24 is activated, for example by operator input, the race control GPS device 15 records the then-current location (e.g., longitude and latitude) of the device in the data storage memory 26.

In the preferred embodiment of the invention, the race control GPS device 15 is adapted to store coordinates for a first selected position P1 and a second selected position P2 when the location selection user interface 24 is activated at two different positions (e.g., positions P1 and P2).

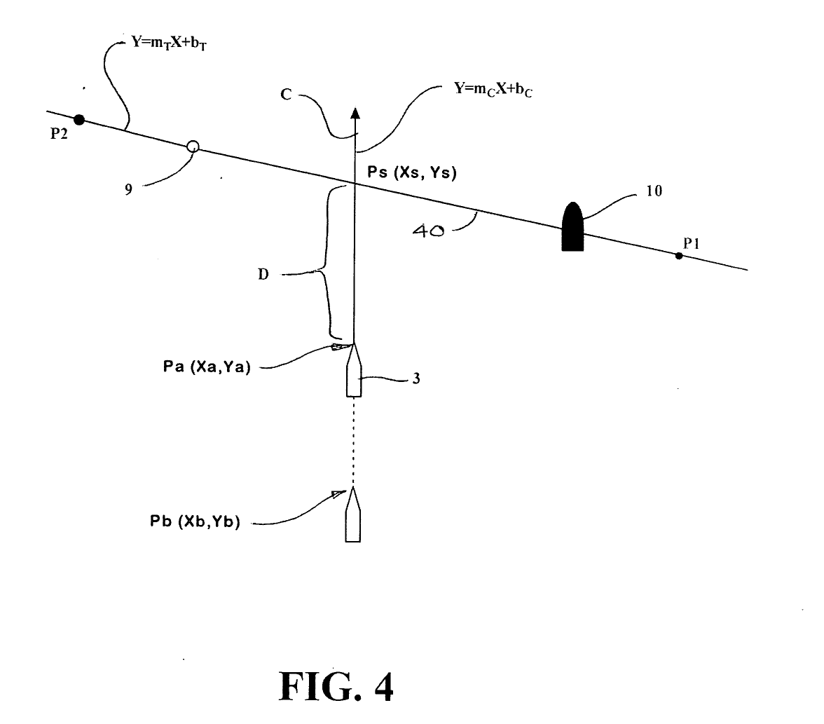

Referring now to FIGS. 4 and 6: In a preferred embodiment of the invention, the GPS processor 22 is connected to a data processing unit 23. Data processing unit 23 preferably converts position data (e.g., longitude and latitude) to Cartesian (i.e., x-y) coordinates. For any two points (e.g., P1, P2 or Pₐ, P_{b}) selected, stored and converted to Cartesian coordinates, the data processing unit 23 then calculates the equation of the straight line that passes through those two points. Such a line can be mathematically expressed in the general form y=mx+b, where “m” is the slope of the line in the particular x-y plane used, and “b” is the distance above the x-axis at which the line intercepts the y-axis.

The race control GPS device 15 continuously monitors the location (e.g., longitude and latitude) of the unit. The GPS processor 22 and data storage memory 26 records the then-current location of the unit at timed intervals. By comparing a first recorded location (P_{b}) to a second recorded location (Pₐ), and determining the distance between the two locations, then dividing that distance by the time interval between which the two were recorded, the GPS processor calculates the location, bearing and speed (S) at which the unit is traveling at any given time. In FIG. 4, Pₐ refers to the current position of sailboat 3, and P_{b} refers to a recent previous position of sailboat 3.

The GPS processor preferably receives and records then-current position data at regularly timed intervals. In the preferred embodiment of the invention, at least the last two recorded positions (Pₐ, P_{b}) are stored in the data storage memory 26. The data processing unit 23 converts the global position data for at least the most recent last two recorded positions (Pₐ and P_{b}), as well as the global position data for the previously selected and stored positions (P1 and P2), to respective coordinates in the same planar coordinate system.

In the preferred embodiment of the invention, the GPS data processing unit 23 converts global position data (e.g., longitude and latitude) for the last two recorded positions (Pₐ, P_{b}) to Cartesian (i.e., x-y) coordinates. For any two such points (Pₐ, P_{b}), the data processing unit 23 then calculates the equation of the straight line that passes through those two points. Such a line, which corresponds to the course line (C) along which the unit is currently traveling, can be mathematically expressed in the form y=m_{c}x+b_{c}, where “m_{c}” is the slope of the line and “b_{c}” is point above the x-y origin at which the line intercepts the y axis.

In the Cartesian system, the last such positioning point (Pₐ) will have a location designated Pₐ(Xₐ, Yₐ); and the next-to last such positioning point (P_{b}) will have a location designated P_{b}(X_{b}, Y_{b}). The bearing (m_{c}) at which the unit is currently traveling corresponds to the slope of the line that extends between these two points P_{b}, Pₐ, namely m_{c}=[Yₐ−Y_{b}]/[Xₐ−X_{b}].

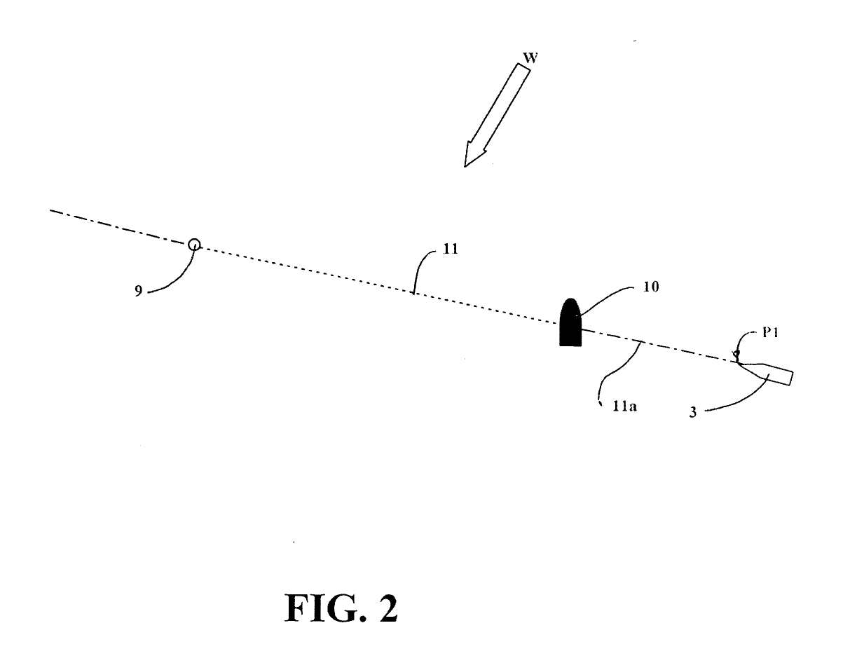

Referring now to FIG. 2: In operation, prior the starting sequence of a race, sailboat 3 is provided with race control GPS device 15 which is mounted or carried aboard sailboat 3. Sailboat 3 advantageously positions itself (or, more particularly, positions itself and the race control GPS device 15 being carried thereon) at any position P1 along an extension 11a of the starting line 11, preferably beyond the committee boat 10. The extension 11a of the starting line 11 can be ascertained when the sailboat arrives at a location (P1) where the sailboat 3, the committee boat 10 and the race buoy 9 are visually aligned with one another. An operator on the sailboat then activates the location selection user interface 24, thereby causing the location of the first selected position (P1) of the boat to be recorded by the data storage memory 26.

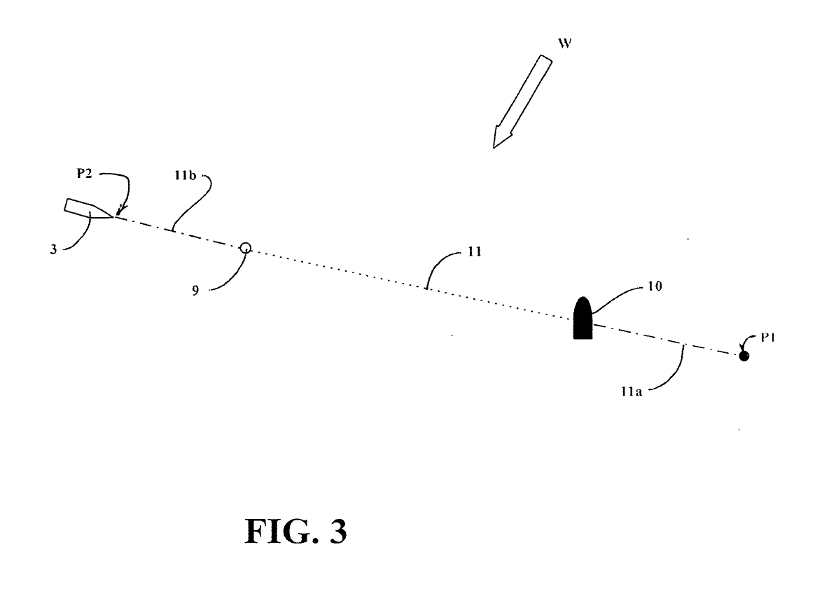

Referring now to FIG. 3: Sailboat 3 then advantageously positions itself (or, more particularly, positions itself and the race control GPS device 15 being carried thereon) at another position P2 along an extension 11b of the starting line 11, preferably beyond the race buoy 10. The extension 11b of the starting line 11 can be ascertained when the sailboat arrives at a location (P2) where the sailboat 3, the committee boat 10 and the race buoy 9 are visually aligned with one another. An operator on the sailboat then activates the location selection user interface 24, causing the location of the second selected position (P2) of the boat to be recorded by the data storage memory 26.

Referring again to FIG. 4: In the manner described above, GPS data Processing unit 23 calculates the equation of the straight line point that passes through the first and second selected positions P1, P2, on the same Cartesian grid and with respect to the same x-y axis as for course path (C), as described above; this is the equation of a “target line” 40, which coincides with the start line 11.

By simultaneously solving the equations of course path (C) [where y=m_{c}+b_{c}] and the target line 40 [where y=mₜ+bₜ], the GPS data processing unit 23 calculates the coordinates of the point (the “Start Point”, Pₛ) at which the course path (C) intersects target line 40.

Once the coordinates of the Start Point Pₛ have been calculated, GPS data processing unit 23 calculates the distance (D) from the sailboat's current position Pₐ to the Start Point Pₛ. Mathematically, this distance (D) equals

Square Root [(Xₛ−Xₐ)²+(Yₛ−Yₐ)²]

where,
Xₛ, Yₛ are the coordinates of the Start Point Pₛ
And Xₐ, Yₐ are the coordinates of the sailboat's current position.

Once the distance (D) from the sailboat's current position Pₐ to the Start Point Pₛ has been calculated, GPS data processing unit 23 calculates the time it takes to traverse that distance at the sailboat's current speed. Mathematically this can be calculated by the equation

T=D/S

where,
T is the time (in seconds),
D is the distance (in feet) between sailboat's current position Pₐ and the Start Point Pₛ, and
S is the current speed (in feet/second) of the sailboat

The actual satellite information taken in by the receiver is the same as in the prior art. The system invented requires the registration of a sufficient plurality of pseudorange information sets from available global positioning satellite vehicles in orbit above the receiving station having an antenna to receive satellite information relevant to global positioning. As in the prior art, each of the information sets includes a predetermined block of information with respect to both the transmitting satellite and the receiving station listening for the information. The information registered may be stored locally or transmitted in raw or modified form to another receiving station (not shown).

Local data storage could be accomplished within the actual GPS receiver or in an on-board computer. Alternatively, a separate computing device or system could be externally connected to accomplish the same result.

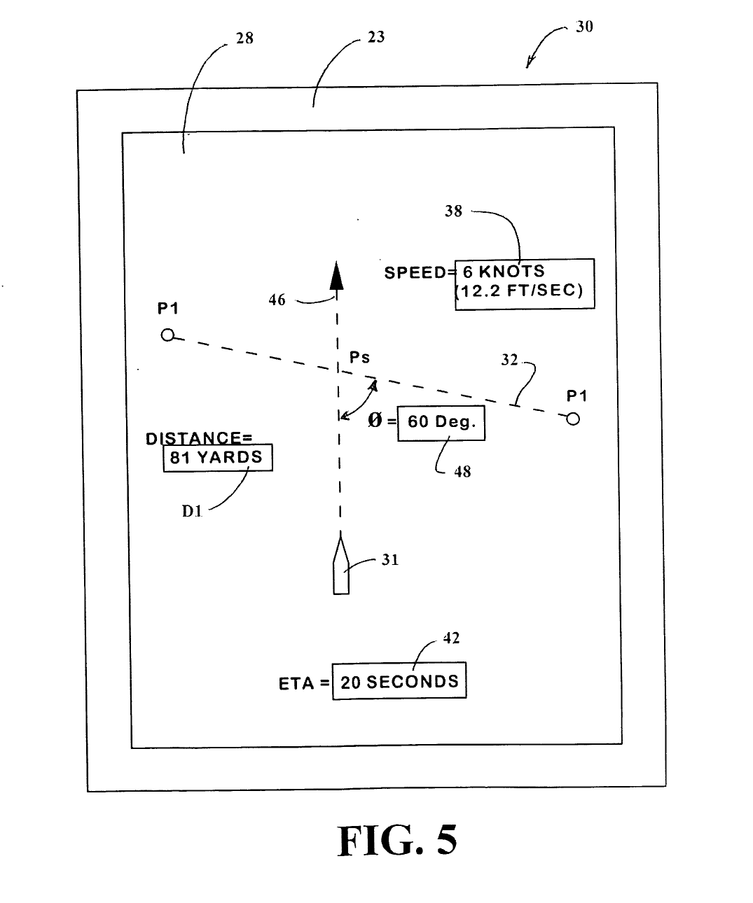

FIG. 5 shows a schematic representation of a display console 30 including a GPS data processing unit 23 coupled to a display screen 28 responsive to input position (or velocity) and residual indications as to the locations of sailboat 3. As shown on display 28, sailboat 3 is preferably indicated as a boat icon 31 with tapered bow and elongated sides. Circular icons represent user selected datum positions P1 and P2. A dashed line 32 extending between the circular icons represents the target line (40). It will be understood that, since P1 and P2 are preferably user selected positions that are beyond the ends (namely, buoy 9 and committee boat 10) of the start line, the actual ends (namely buoy 9 and committee boat 10) may not be represented on the display screen 28.

According to one embodiment of the present invention, at the beginning of a race start sequence (e.g., ten minutes before the start), a start gun is fired and a flag or shape is raised on a committee boat. The same or another gun is fired with five minutes to go before the start of the race. During the start sequence, the racing boats will compete for optimal position with respect to the remaining boat, with the intent of traversing the start line just as the race start gun goes off.

The information provided to data processing unit 23 and display 28 is preferably transmitted via hard wire connection between the GPS processor 22 and the data processing unit 23. In an alternative embodiment of the invention information provided to data processing unit 22 and display 28 may be sent via radio transmission.

In the preferred embodiment of the invention, the display 28 graphically portrays the relative angle of approach 0 of the current path (C) of the sailboat 3 (graphically represented by sailboat icon 31) and the target line 40, in a given X-Y plane, as well as the sailboat's current speed 38 and its distance (graphically represented by D1) to the point of its projected intersection (i.e., start point Pₛ) with the target line 40. Accordingly, it will be understood that, in the preferred embodiment of the invention, it is neither necessary nor desired to display the target line on the display screen 28 at the start line's actual compass orientation (e.g., such that North is toward the “top” of the screen); nor is it necessary or desirable to graphically display the sailboat's 3 actual compass orientation (e.g., relative to North). All that is necessary in this regard is that the relative orientations of the target line 40 and the boat's course (C) be accurately illustrated.

In a preferred embodiment of the invention, as shown in FIG. 5, the sailboat icon 31 always points towards the “top” of the screen (i.e., in the positive Y direction); and the slope of the target line 40 displayed on the screen correspondingly changes as the angle of approach θ calculated by the processing unit 23 is periodically updated/changed.

Also, in a preferred embodiment of the invention, the start point Pₛ (that is, the point at which the sailboat's current path (C) intersects the target line 40) is displayed on the display screen 28 in a fixed location on the screen, preferably approximately laterally centered, as shown in FIG. 5. In this embodiment, then, the path (C) of the sailboat and the start point Pₛ are always shown in the same position on the screen, while the target line 40 pivots around the start point Pₛ as the angle of approach θ changes.

The scale of the graphics on the display screen 28 is preferably chosen such that distances from P1 to P2 and from the sailboat icon 31 to the start point Pₛ both can fit within the screen. The distance from the sailboat 3 to the start point Pₛ may be graphically displayed on the screen 28 to the same scale as the distance from P1 to P2. As the sailboat 3 approaches the start point Pₛ the length (D1) of the line from the sailboat icon 31 to the target line 40 decreases correspondingly.

As discussed above, in order to establish a target line 40 corresponding in orientation and position to a start line 11, two user selected points (P1, P2) must be input to the GPS device 15. This is accomplished by the user's interaction with a user interface device 24, which is in communication with the GPS processor 22. In the preferred embodiment of the invention, the user interface device 24 comprises a graphical user interface (GUI), whereby the user identifies a selected position (e.g., P1 or P2) by cursor placement and “clicking” on an appropriate menu item shown on the display screen 28, or, alternatively, by touching an appropriate menu item on a “touch screen” enabled display screen. In alternative embodiments of the invention, the user interface 24 may comprise a user-interactive keyboard or toggle switch for identifying the selecting positions P1, P2.

The position and residuals information received by data processing unit 23 produces indications such as position indications for sailboat 3 relative to target line 40, a historical track indication (not shown, but implementable as the track of prior positions of sailboat 3 relative to target line 40), a current speed 38 over ground, the intercept angle θ between the sailboat's current course (C) and the target line 40, and an estimated time of arrival (ETA) 42 at the intercept between the course of sailboat 3 and the target line 40. As shown in FIG. 5, the position of sailboat, current projected intercept angle, and estimated time of arrival, can be affirmatively represented on display screen 28 next to icons/graphics of sailboat 31, current course 46, distance to intercept D1, and target line 40.

On the display screen 28, the icons representing user selected positions P1 and P2 can be connected by a dashed line indicating the target line 40, which in accordance with the present invention corresponds, insofar as angle of intercept and distance to sailboat 3, to start line 40. Display screen 28 may be a conventional cathode ray tube (CRT) or liquid crystal display (LCD) or any of a number of currently used display types.

It will be understood from the preceding description of the present invention that, by viewing the display, the skipper, navigator, or strategist onboard sailboat 3 (or all of them) are provided with a symbolic status representation including essential stationing information with regard to sailboat 3 and start line 11. The skipper may accordingly produce change of station or velocity instructions to the crew to ensure timely crossing of start line 11. As shown in FIG. 6, the sailboat icon 31 has attached at its foremost tip velocity vector 46 as an indication of the current course of sailboat 3, which can be derived as described herein above by comparing sequential position indications (Pₐ, P_{b}) for sailboat 3. These user-friendly indications on a suitable display, either on a stand-alone display unit on the bridge of sailboat 3 or on a hand-held, personal digital assistant (PDA), smart phone or portable GPS can be useful for user-friendly sailing decision making, either by crew or captain.

As described above, the present invention a graphic display screen 28 is employed for showing time, distance, angle of approach and other information that may be useful for managing start line approach of a racing sailboat. In a preferred embodiment of the invention, global positioning data is received by a GPS receiver 20, and global positioning data is converted by GPS data processing unit 23 to Cartesian coordinates, whereby various identified locations (namely, P1, P2, P_{b}, Pₐ, P_{b}) can all be plotted in a common plane.

Various methods of converting global coordinates (such as longitude and latitude) to Cartesian coordinates are know in the prior art. One such Cartesian coordinate system that is widely used for plotting locations of points on the Earth's surface is called the “Universal Transverse Mercator System” (or, UTM). In this system the globe is subdivided into narrow longitude zones, which are projected onto a transverse Mercator projection. A grid is constructed on the projection and used to locate points in an X-Y (so called “easting” and “northing”) format.

Equations for converting latitude and longitude coordinates to UTM, although fairly complicated and somewhat tedious, are well known in the prior art. One method of converting latitude and longitude to UTM is given below. In the following equations, the following symbols have the following meanings:
lat=latitude of point
long=longitude of point
long₀=central meridian of zone
k₀=scale along long₀=0.9996.
e=SQRT(1−b²/a²)=0.08 approximately. (This is the eccentricity of the earth's elliptical cross-section.)
e′²=(ea/b)²=e²/(1−e²)=0.007 approximately. (The quantity e′ only occurs in even powers so it need only be calculated as e′².)
n=(a−b)/(a+b)
rho=a(1−e²)/(1−e² sin²(lat))^{3/2}. (This is the radius of curvature of the earth in the meridian plane.)
nu=a/(1−e² sin²(lat))^{1/2}. (This is the radius of curvature of the earth perpendicular to the meridian plane. It is also the distance from the point in question to the polar axis, measured perpendicular to the earth's surface.)
p=(long−long₀) in radians

First, the meridional Arc (M) through the point in question, (i.e., the distance along the earth's surface from the equator) is calculated. All angles are in radians.

M=A′lat−B′ sin(2lat)+C′ sin(4lat)−D′ sin(6lat)+E′ sin(8lat)

Where lat is in radians and
A′=a[1−n+(5/4)(n²−n³)+(81/64)(n⁴−n⁵) . . . ]
B′=(3 tan S/2)[1−n+(7/8)(n²−n³)+(55/64)(n⁴−n⁵) . . . ]
C′=(15 tan² S/16)[1−n+(3/4)(n²−n³) . . . ]
D′=(35 tan³ S/48)[1−n+(11/16)(n²−n³) . . . ]
E′=(315 tan⁴ S/512)[1−n . . . ]

The latitude and longitude of the point in question can now be calculated as follows:

All angles are in radians, and easting x is relative to the central meridian.

y=northing=K1+K2p²+K3p⁴, where
K1=Sk₀,
K2=k₀ nu sin(lat)cos(lat)/2=k₀ nu sin(2 lat)/4
K3=[k₀ nu sin(lat)cos³(lat)/24][(5−tan²(lat)+9e′² cos²(lat)+4e′⁴ cos⁴(lat)]

x=easting=K4p+K5p³, where
K4=k₀ nu cos(lat)
K5=(k₀ nu cos³(lat)/6)[1−tan²(lat)+e′² cos²(lat)]

In the case of each of the embodiments noted or suggested herein, differential GPS corrections can be applied according to techniques well-known in the art, to improve the absolute accuracy of the position information determined. As is well known, differential GPS corrections can be obtained by use of a reference station, which is positioned at a known location. When reference station makes a GPS measurement which deviates from its known location value, the difference between known and measured values constitutes a correction which can be applied in the GPS calculations of other GPS receivers within several hundred miles of the reference station. According to one embodiment of the present invention, referring to a GPS measurement shall include reference to a differentially corrected GPS measurement.

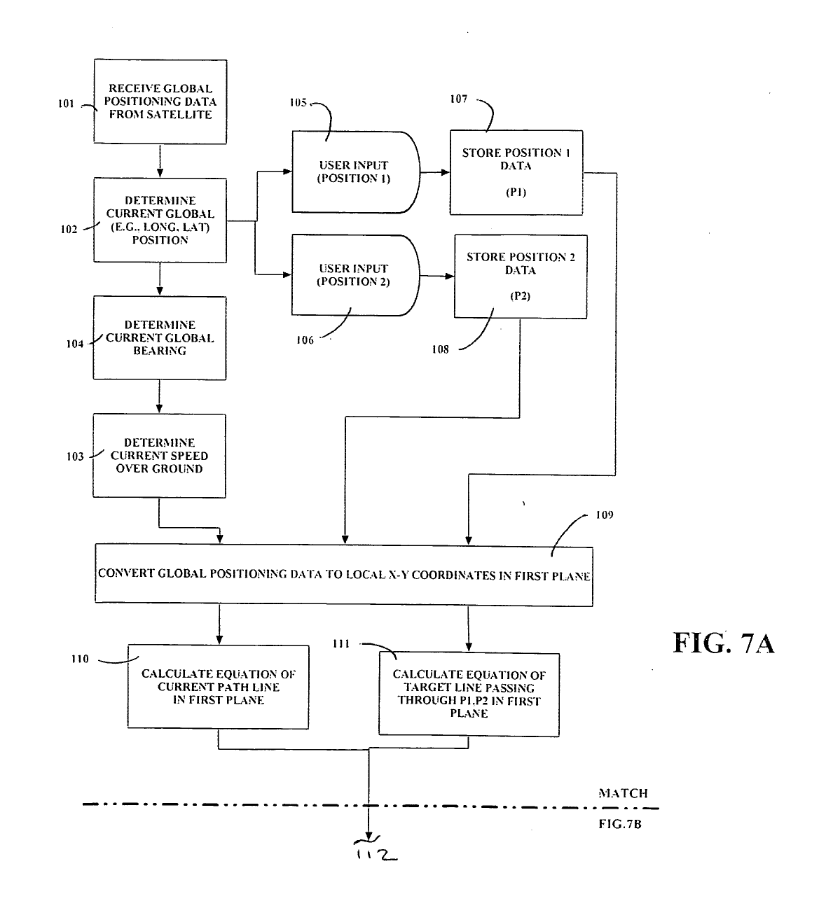

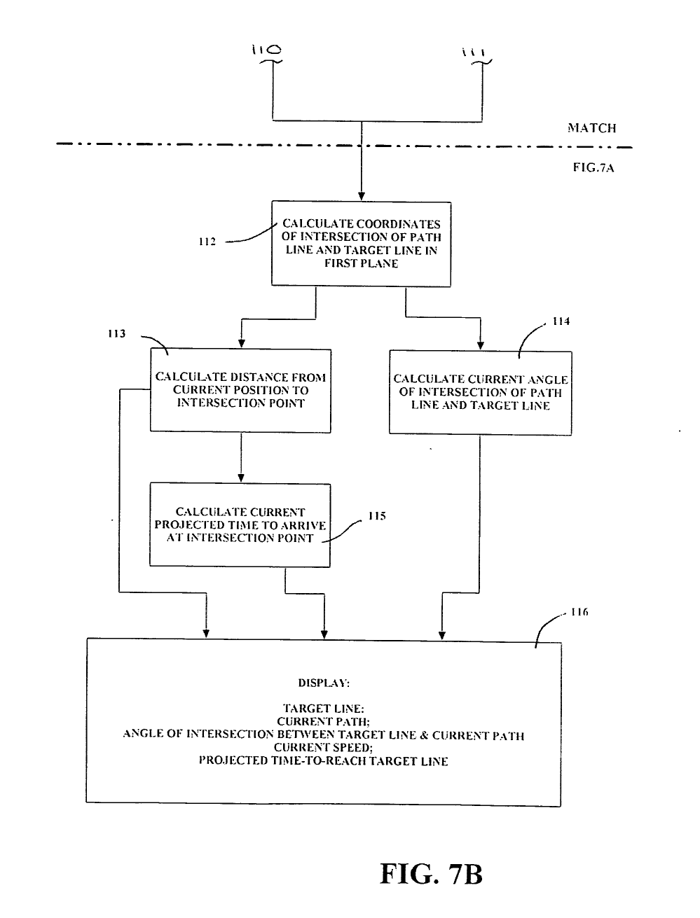

FIG. 7 illustrates steps involved in employing the above-described system to generate sailboat positioning, timing and angle of intercept with a race start line in accordance with an embodiment of the present invention. Global positioning data is received from orbiting satellites 101; the current global position of the receiver is determined 102; the current global bearing (direction of travel) of the receiver is determined 103; the current speed over ground of the receiver is determined 104. User inputs (105, 106) cause the then-current position (P1, P2) to be stored 107, 108. The global positioning data is converted 109 to local x-y coordinates in a first plane. The equation 110 of the current path line 110, the equation 111 of the target line, the coordinates 112 at which the target line and path line intersect, the distance 113 from the current position to the intersection point, the current angle 114, and the projected time of arrival at the target line are each calculated. The calculated information (e.g., target line, current path, angle of intersection, speed and/or time to reach target line) are displayed 116 on the display screen.

The present invention has been described herein above with respect to management and control of a racing vehicle, such as a sailboat, as it approaches the start line of a race. It will it will be appreciated by those skilled in the art that the present invention can similarly be used in some instances with respect to management and control of a racing vehicle as it approaches the finish line of a race.

For example, as a sailboat approaches a finish line on its final tack, there is often a preferred end at which to cross the line. Generally, the “preferred” end of the line is the end that the boat can sooner cross. This is often, by not always, the end that is closest to the approaching sailboat. In any event, it is often difficult to visually determine, from several hundreds of yards or more away from the finish line, which part of the line is closest (either in time or in distance) to the sailboat.

In a preferred method of using the present invention, prior to starting a race, a pair of line shots are taken from positions (e.g., P1, P2) on an extension of the finish line. The finish line may be the same as the start line (as illustrated in FIGS. 1-4), or the finish line may be different from the start line (not illustrated). In a manner similar to that described above, the race control global positioning system (GPS) device 15 calculates the boat's speed, current course and the target line (i.e., the finish line), and determines the projected amount of time that it will take for the boat to cross the finish line at its current bearing and speed. By changing the heading of the boat, and monitoring whether the projected time to cross the finish line increases or decreases, the helmsman can optimize boat's course to the finish line by selecting the heading with the minimum projected time to cross the finish line.

In various advantageous embodiments, portions of the system and method of the present invention include a computer program product. The computer program product includes a computer-readable storage medium, such as the non-volatile storage medium, and computer-readable program code portions, such as a series of computer instructions, embodied in the computer-readable storage medium. Typically, the computer program is stored and executed by a processing unit or a related memory device, such as the GPS processor 22, data processing element 23 or data storage memory 26 as depicted in FIG. 6.

In this regard, FIGS. 6 and 7 are block diagrams and flowchart illustrations of a system and program product according to the invention. It will be understood that each block or step of the block diagram, flowchart and control flow illustrations, and combinations of blocks in the block diagram, flowchart and control flow illustrations, can be implemented by computer program instructions. These computer program instructions may be loaded onto a computer or other programmable apparatus to produce a machine, such that the instructions that execute on the computer or other programmable apparatus create means for implementing the functions specified in the block diagram, flowchart or control flow block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the block diagram, flowchart or control flow block(s) or step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the block diagram, flowchart or control flow block(s) or step(s).

Accordingly, blocks or steps of the block diagram, flowchart or control flow illustrations support combinations of means for performing the specified functions, combinations of steps for performing the specified functions and program instruction means for performing the specified functions. It will also be understood that each block or step of the block diagram, flowchart or control flow illustrations, and combinations of blocks or steps in the block diagram, flowchart or control flow illustrations, can be implemented by special purpose hardware-based computer systems which perform the specified functions or steps, or combinations of special purpose hardware and computer instructions.

Modified embodiments of the invention. Although there has been shown and described the preferred embodiment of the present invention, it will be readily apparent to those skilled in the art that modifications may be made thereto which do not exceed the scope of the appended claims. For example:
The present invention provides a method, apparatus and GPS device by which a skipper can effectively manage and control a racing sailboat as it approaches the start line of a race. It will be understood from the foregoing description that, in accordance with the present invention, an (infinitely long) “target line” that corresponds to, but is not the same length as, the start line. In fact, in the present invention the end points of the starting line are not entered into the GPS device. It will be appreciated by those skilled in the art, however, that as long as the racing boat is aimed at the starting line, and at least one of the ends of the starting line (i.e., either the committee boat or the pin) are visible to the boat's skipper, it is not necessary to electronically store or display the coordinates of the starting line's ends in order to advantageously practice the present invention.
The data processing unit 23 may calculate, and the data storage memory 26 may maintain a historical record of all previously received positioning data, and such data, including historical path of sailboat relative to target line, may be displayed on the display screen.
In a preferred embodiment of the invention, global positions computed by the race control GPS device 15 are indentified according to the positions' respective longitude and latitude. It is within the scope of the present invention, however, that the GPS device may receive and/or generate global positioning data based on other coordinate systems other than latitude and longitude.
In a preferred embodiment of the invention, global positioning data received from satellites is converted by data processing unit 23 to Cartesian coordinates. It is, however, within the scope of the present invention for other, alternative, coordinate systems to be used, provided, however, that the target line 40, the user selected positions P1, P2, and the current and previous positions of the boat-carried GPS receiver 20 all be calculated and describable in a common plane.
In a modified embodiment of the invention, the time, angle of crossing, and/or distance to crossing of the target line are alpha-numerically displayed. In this embodiment of the invention, it is not necessary that the display screen include graphical images (such as icons or the target line or the boat course line, etc.).
In a modified embodiment of the invention, there is no display screen, and the device activates a digital signal (i.e., with sound generator 36) when the unit is approaching and/or crosses the target line.
The present invention has been described herein above for advantageous use in management and control of a racing sailboat as it approaches a start or finish line. It will be appreciated by those skilled in the art, however, that the present invention can alternatively be advantageously used for management and control of types of vehicles other than sailboats, and for approaching target lines other than race start and finish lines.
The present invention has been described herein above for advantageous use in management and control of a vehicle (for example a sailboats) as it approaches a target line. It will be appreciated by those skilled in the art, however, that the present invention can alternatively be advantageously for pedestrians approaching target lines.
In a preferred embodiment of the invention, the point at which the sailboat's current path (C) intersects the target line 40) is displayed on the display screen 28 in a fixed location on the screen, preferably approximately laterally centered, and the target line 40 pivots around the start point Pₛ as the angle of approach changes. It is within the scope of the present invention, however, to display such information an other formats and different graphics.
Local storage of positioning data could be accomplished within the actual GPS receiver or in an on-board computer. Alternatively, a separate computing device or system could be externally connected to accomplish the same result.
The start line could alternatively defined by two buoys, a day mark and a buoy, a committee boat and a buoy or day mark or other structure.

Therefore, it is to be understood that the invention is not to be limited to the specific embodiments disclosed and that modifications and other embodiments are intended to be included within the scope of the appended claims.

What is claimed is:

1. A marine-based system for assisting in boat racing across a predetermined start or finish target line defined by first and second line markers disposed at opposite ends of said target line, said system comprising:
a global positioning system (GPS) receiver for installation on a first racing vehicle, said GPS receiver being capable of producing global positioning indications of the position of said GPS receiver based upon received GPS satellite transmissions,
a data processor connected to said GPS receiver,
a user input interface connected to said data processor,
wherein said data processor records a first global positioning indication datum point corresponding to the position of said GPS receiver when said user input interface is activated and said GPS receiver is positioned at a first global position;
and said data processor records a second global positioning datum point corresponding to the position of said GPS receiver when said user input interface is activated and said GPS receiver is positioned at a second global position;
said data processor determining a mathematical equation of a first target line in a first plane, wherein said first target line in said first plane passes through coordinates corresponding to said first positioning datum point and said second positioning datum point;
a clock component connected to said GPS receiver, and said GPS receiver producing a plurality of time spaced-apart global positioning indications of respective positions of said GPS receiver,
wherein said processor records a first global positioning course datum point corresponding to a first of said plurality of time spaced-apart global positioning indications of respective positions of said GPS receiver;
and said processor records a second global positioning course datum point corresponding to a second of said plurality of time spaced-apart global positioning indications of respective positions of said GPS receiver;
said data processor further determining a mathematical equation of a first course line in said first plane, wherein said first course line in said first plane passes through coordinates corresponding to said first positioning course datum point and said second positioning course datum point;
and wherein said processor calculates the speed of travel of said GPS receiver between said first global positioning course datum point and second global positioning course datum point;
and said processor calculates an intersection point in said first plane at which said first course line and said first target line intersect;
and said processor calculates the distance between said second global positioning course datum point and said intersection point;
and said processor calculates for output a projected amount of time it will take to travel from said second global positioning course datum point to said intersection point.

2. The system according to claim 1, further comprising:
a display screen connected to said processor,
and wherein said output of said projected amount of time comprises displaying time-to-intersect data on said display screen.

3. The system according to claim 2, further comprising:
an audio signal generator connected to said processor,
and wherein said output of said projected amount of time further comprises an generating an audible signal.

4. The system according to claim 3, wherein said processor further determines a first course bearing in said first plane, said first course bearing corresponding to an angle between said course line and said target line.

5. The system according to claim 4, wherein said course line and said first target line are graphically depicted on said display screen.

6. The system according to claim 5, wherein said distance between said second global positioning course datum point and said intersection point is depicted on said display screen.

7. The system according to claim 6, wherein said first global positioning indication datum point and said second global positioning indication datum point are each depicted on said display screen.
